(19) United States
(12) Patent Application Publication
(10) Pub. No.: US 2025/0385873 A1
(43) Pub. Date: Dec. 18, 2025

(54) SYSTEM AND METHOD FOR SELECTING AN UPSTREAM MESSAGE IN A COOPERATIVE VEHICLE PLATOON

(71) Applicant: TOYOTA MOTOR ENGINEERING & MANUFACTURING NORTH AMERICA, INC., PLANO, TX (US)

(72) Inventors: Sergei S. Avedisov, Redwood City, CA (US); Ahmadreza Moradipari, Mountain View, CA (US); Hongsheng Lu, San Jose, CA (US); John Kenney, Santa Clara, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/742,981

(22) Filed: Jun. 13, 2024

(51) Int. Cl. H04L 47/25; G05D 1/65; G05D 1/698; G05D 109/10; G05D 111/30; H04W 4/46; H04W 24/08; H04W 72/21

(52) U.S. Cl. CPC H04L 47/25; G05D 1/65; G05D 1/6985; H04W 4/46; H04W 24/08; H04W 72/21; G05D 2109/10; G05D 2111/30

(57) ABSTRACT

A system is provided for implementing an upstream message selection system that dynamically changes a message type for a cooperative vehicle platoon such that traffic congestion is mitigated and the damping properties of the platoon tail are improved. The upstream message selection system analyzes the current traffic conditions in a real-real time driving scenario to determine when increasing a frequency of transmitting messages are failing to sufficiently mitigate a traffic disturbance. The upstream message selection system determines that increasing the transmission rate of basic safety messages (BSMs) is sufficiently attenuating a traffic disturbance in a real-real time driving scenario. In response to detecting that increasing the frequency of BSMs is failing to efficiently attenuate a traffic disturbance, the upstream message selection system dynamically changes the message type from BSM to an intent maneuver message for the upstream vehicles based on the downstream response to a disturbance within the platoon.

### TECHNICAL FIELD

The present disclosure generally relates to vehicle communication and vehicle navigation and/or computer-controlled driving technology. In particular, data from a plurality of vehicles having communication capabilities can be used in determining actions, such as dynamically changing a type of communication messages, for vehicles to perform in order to mitigate traffic disturbance.

### DESCRIPTION OF RELATED ART

Traffic detection generally involves devices or systems that have the capability to detect the presence or movement of vehicles. These devices can then relay the information which is analyzed, typically by centralized servers or computational nodes, to aide in detecting real-time traffic or observing traffic patterns over time. Various types of existing traffic detection mechanisms can include: in-roadway sensors that sit on and/or under the surface (e.g., on pavement, on the surface of the road, etc.) to detect traffic-flow by detecting pressure changes that occur on the road surface; over roadway sensors (e.g., ultrasonic and passive infrared sensors) that sit above the road, and are often installed on the roadway or alongside the road, closest to vehicle movement on roads. Some common types of over roadway sensors include navigation systems, which typically include application platforms, to collect real-time information (e.g., vehicle speed, traffic conditions, and road structures) from sensors implemented on and/or near the vehicle to remotely located centralized systems to detect the presence of traffic and recognize traffic patterns.

In many cases, traffic detection serves as the basis for handling various other operational tasks of the vehicles. For example, if a vehicle is approaching a route where traffic congestion is detected, the vehicle may be alerted to slow down and/or rerouted. Overall, traffic detection and management of roadways is important, as ever-increasing rates of traffic issues across roads today is becoming a challenge. Using mechanisms such as traffic detection systems can be crucial in solving such problems, and can allow for drivers and/or vehicles to make the right adjustments to make congestion easy to manage and reduce collisions, injuries, and other potential hazards.

### BRIEF SUMMARY OF THE DISCLOSURE

In accordance with embodiments of the disclosed technology, a system may comprise a processor device analyzing data associated with a driving environment of a vehicle and selecting an updated transmission rate or an updated type of communication messages for the vehicle to transmit in response to a traffic disturbance detected in the driving environment. The data can comprise communication messages of an initial type transmitted at an initial transmission rate by a plurality of communicatively connected vehicles in the driving environment. The system can also include a controller device executing autonomous actions to maneuver the vehicle based on the updated type of communication messages for the vehicle.

A non-transitory computer readable medium comprising instructions, that when read by a processor, cause the processor to perform analyzing data associated with a driving environment of a vehicle and selecting an updated transmission rate or an updated type of communication messages for the vehicle to transmit in response to a traffic disturbance detected in the driving environment. The data can include communication messages of an initial type that are transmitted at an initial transmission rate by a plurality of communicatively connected vehicles in the driving environment. The non-transitory computer readable medium comprises instructions, that when read by a processor, cause the processor to further perform executing autonomous actions to maneuver the vehicle based on the updated type of communication messages for the vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1D illustrate an example road environment including vehicles implementing an upstream message selection system to mitigate a traffic disturbance, in accordance with an embodiment of the technology disclosed herein.

FIG. 2 is a flow diagram of an example method implementing upstream message selection in order to mitigate a traffic disturbance, in accordance with an embodiment of the technology disclosed herein.

FIG. 3 depicts an example network architecture of an in-vehicle upstream message selection system, in accordance with an embodiment of the technology disclosed herein.

FIG. 4 is a schematic representation of an example vehicle with which embodiments of the upstream message selection system disclosed herein may be implemented.

FIG. 5 is an example computing component that may be used to implement various features of embodiments described in the present disclosure.

The figures are not exhaustive and do not limit the present disclosure to the precise form disclosed.

### DETAILED DESCRIPTION

Some vehicles include computer-controlled operational modes, such as vehicles having adaptive cruise control mode and automated vehicles, in which a computing system is used to navigate and/or maneuver the vehicle along a travel route. During adaptive cruise control operation, for example, the driving speed of the vehicle can be limited by various factors, such as traffic congestion (e.g., preceding vehicles travelling at slower speeds, preceding vehicles stopped). In another example, many existing vehicle navigation systems alert a driver of the presence of traffic along an intended route, in order to provide traffic related information that may be pertinent to driving, such as alternate routes, time delay estimations, or automated driving actions.

Furthermore, vehicles can include advancements and innovations in safety that help prevent crashes, collisions, and other dangerous conditions in order to protect drivers and passengers. For example, some vehicles are equipped with technology, such as computer-controlled vehicle safety systems and collision avoidance systems, that are designed to support driver awareness, decision making and vehicle operation over a wide range of speeds. Thus, the mechanisms employed by vehicles to detect traffic congestion should have relatively high accuracy, especially when utilized with computer-controlled operational modes (e.g., detecting traffic directly impacts operation of the vehicle and/or collision avoidance systems).

However, some currently-employed mechanisms for traffic detection, such as navigation systems, rely on drivers sharing real-time information (e.g., vehicle speed, traffic conditions, and road structures) to remotely located cloud computing systems and/or edge computing systems. Thus, the overall performance and accuracy of these mechanisms for detecting traffic are dependent upon the reliability and strength of communication between the vehicle and the remote cloud and/or edge computers. For example, in instances where a vehicle's communication to the cloud is weak (or otherwise interrupted) these conventional mechanisms may be incapable of properly collecting the information needed for analysis, and in turn would not be able to provide the driver with accurate traffic detection and other related information (e.g., the most optimal route to their destination) used to efficiently and safely navigate and/or maneuver the vehicle on the road. Thus, it can be advantageous to develop traffic congestion mitigation mechanisms that leverage communication capabilities directly between vehicles, where connected vehicles may act as communication points (as opposed to having to communicate with remote cloud computing and/or edge computing systems).

Cooperative vehicle platooning is one such traffic congestion mitigation mechanism, where vehicles communicate in a manner that attempts to maintain smoothness, uniformity and safety in the movement of vehicular traffic. As referred to herein, cooperative vehicle platooning is a cooperative traffic mitigation technique where a plurality of vehicles travel closely together, for instance in a convoy, and communicate with each other in order to maintain a consistent speed and distance between vehicles. For example, a vehicle system using cooperative adaptive cruise control (CACC) for platooning allows simple dynamics, and adapts to various traffic scenarios that may also involve unconnected vehicles. In this way, the CACC system leverages cooperative vehicle platooning functions to increase vehicle safety, reduce traffic jams, improve energy efficiency, and enhance operator comfort. The benefits achieved by cooperative vehicle platooning often depend on the control system of the ego vehicle and the surrounding traffic. For instance, some vehicle systems implementing cooperative vehicle platooning may not guarantee certain higher performance levels in dense traffic. Moreover, other pertinent parameters and/or factors, such as information age and actuation latency, can play critical roles in the overall performance of cooperative vehicle platooning features. The information age represents the time between when the information is generated at the transmitting vehicle and the time when the information is used by the control algorithm on the receiving vehicle. Additionally, a parameter that significantly impacts the information age is the transmission rate of control messages (e.g., basic safety message (BSM), intent message (Intent MM), etc.). Sending messages more frequently (e.g., a higher transmission rate) allows the receiving vehicle to act using a smaller information age, which typically leads to better performance. Vice versa, a vehicle performing actions based on messages that are transmitted less frequently, and thus having a larger information age, can typically lead to degraded performance. Furthermore, the content of the control messages has a significant impact on the cooperative vehicle platooning performance. As BSMs contain only the most recent information about the transmitting vehicle, the upstream following vehicles (FVs) rely on past information once they receive BSMs. On the other hand, intent messages contain predicted trajectory information (e.g., a speed profile in the future) of the transmitting vehicle, which may give the FVs more context for anticipation of future events. Furthermore, leading vehicles (LV) may be unable to mitigate disturbances in larger platoons relying solely on BSMs. Therefore, in instances when the LVs in a platoon send an intent message towards the platoon tail instead of a BSM, the predictive nature of the intent messages provides more powerful information with respect to reducing disturbances. Accordingly, it may be beneficial to dynamically determine when intent messages can be utilized in certain real-time driving scenarios in a manner that realizes improvements in the overall performance of cooperative vehicle platooning features and further achieves greater vehicle safety, improved traffic mitigation (e.g., reduced traffic jams) and enhanced driver assistance.

In order to address these challenges, the disclosed upstream message selection system is distinctly designed to implement a dynamic change to a message type for a cooperative vehicle platoon such that traffic congestion is mitigated, damping properties of the platoon tail are improved, and the load in vehicle connectivity channels is substantively decreased. The upstream message selection system can analyze the current traffic conditions in a real-real time driving scenario to determine when increasing a frequency of transmitting BSMs are failing to sufficiently mitigate a traffic disturbance. In some embodiments, the upstream message selection system can determine that increasing the transmission rate of BSMs is sufficiently attenuating a traffic disturbance in a real-real time driving scenario by detecting that the vehicle platoon string maintains stable from each preceding vehicle to a FV; and determining whether the velocity/acceleration fluctuations at the vehicle platoon tail are bounded. Subsequently, in response to detecting that increasing the frequency of BSMs fails to efficiently attenuate a traffic disturbance, the upstream message selection system is configured to dynamically change the message type from BSM to an intent maneuver message for the upstream vehicles based on the downstream response to a disturbance within the platoon. In this way, the cooperative vehicle platoon can leverage the dynamic change to intent messages in order to cooperatively to improve the damping properties of the platoon tail and mitigate the traffic disturbance.

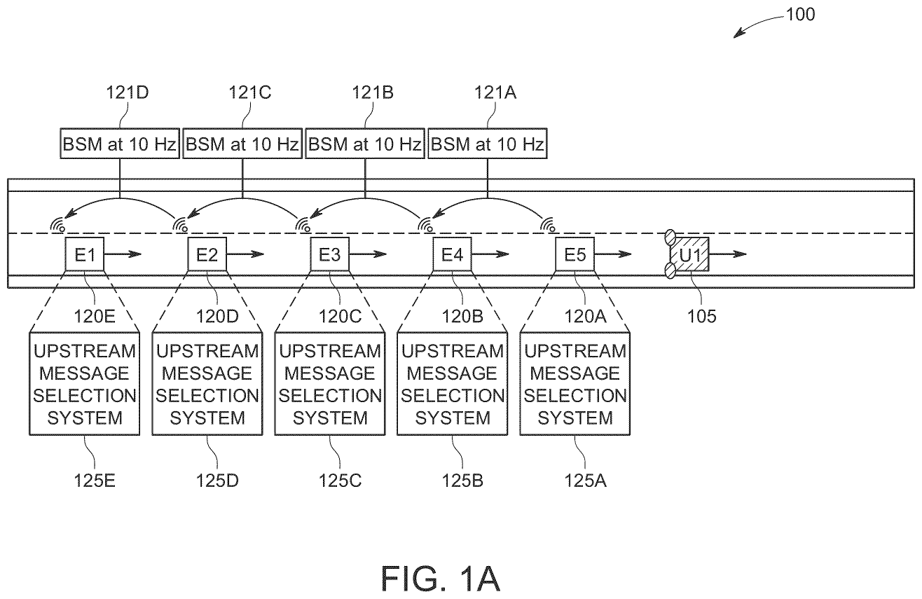

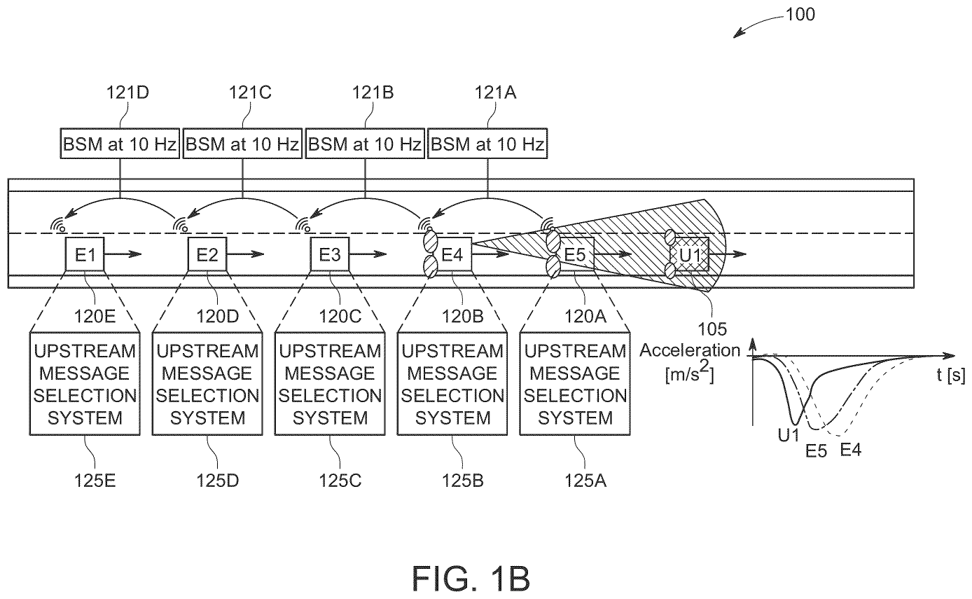

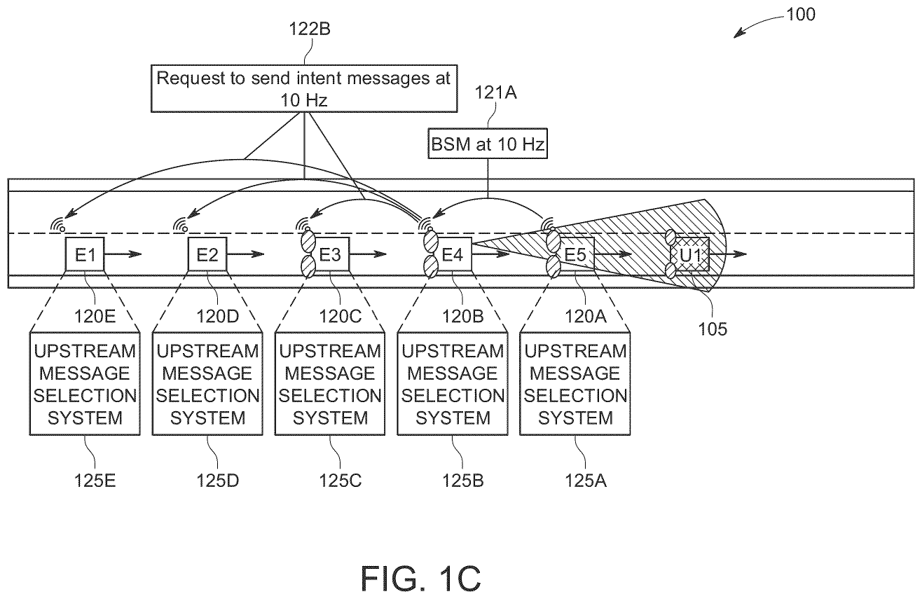

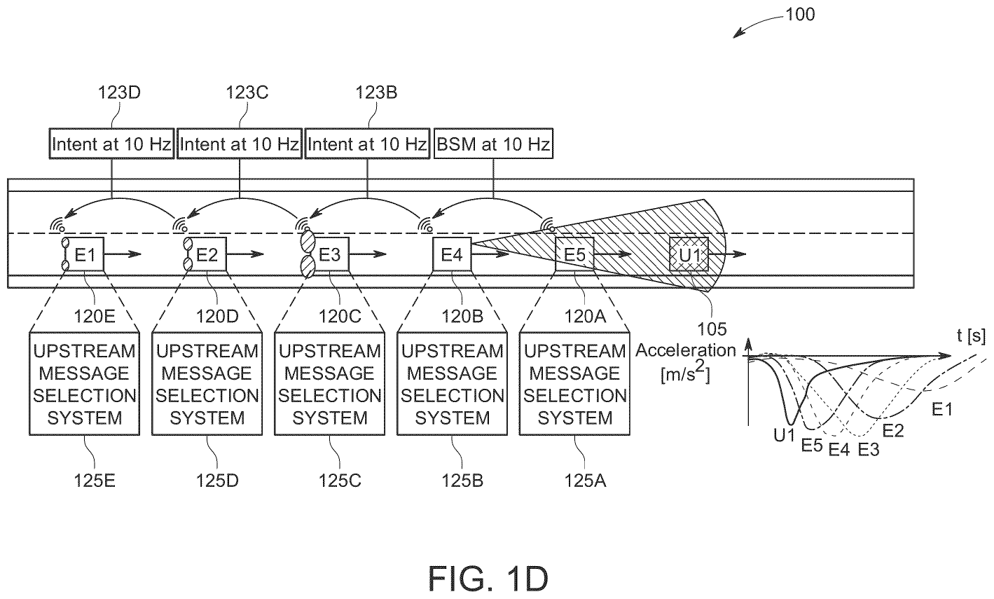

Referring now to FIG. 1A-FIG. 1D, an example of a road environment 100 is depicted, which includes vehicles 120A-120E that are configured as a cooperative vehicle platoon. Additionally, FIG. 1A-FIG. 1D further show that the vehicles 120A-120E are configured to each implement an upstream message selection system 125A-125E respectively, as disclosed herein. Particularly, FIG. 1A-FIG. 1D illustrate in the example of a road environment 100, shown as a two-lane highway, that the plurality of vehicles 125A-125E are traveling in the same lane of the road as a cooperative vehicle platoon. Particularly in the example of FIG. 1A-FIG. 1D, each of the vehicles 120A-120E are shown as being equipped with a respective upstream message selection system 125A-125E. As such, each of the vehicles 120A-120E within the cooperative vehicle platoon is configured to implement upstream message selection, as disclosed herein. Generally, each of FIG. 1A-FIG. 1D depict a successive instance of a driving scenario, where the vehicles 120A-120E function cooperatively to employ the disclosed upstream message selection techniques in order to mitigate a traffic disturbance in a manner that is efficient and safe for drivers.

FIG. 1A illustrates that while vehicle 120A is operational, for instance being driven on the freeway, the vehicle 120A may be traveling at a certain speed in a lane on the road. FIG. 1A also shows that while vehicle 120A is being driven, a plurality of other vehicles 120B-120E are also traveling behind this leading vehicle (LV) vehicle 120A on the road. As seen in FIG. 1A, the vehicles 120A-120E are positioned directly behind each other successively in a convoy, where vehicle 120B directly follows vehicle 120A, vehicle 120C directly follows vehicle 120B, vehicle 120D directly follows 102C, and so on to form the cooperative vehicle platoon of vehicles 120A-120E being driven in the same lane of the road. In this way, the vehicles 120B-120E can be considered the following vehicles (FVs) in the cooperative vehicle platoon that are positioned upstream in the lane from vehicle 120A, namely the LV. This is a common road environment in several different real life scenarios, for instance driving during rush hours, driving in densely populated areas (e.g., metropolitan areas), and the like. By functioning as a cooperative vehicle platoon, vehicles 120A-120E are communicatively connected to each other by employing vehicular wireless communication technology, such as a vehicle-to-vehicle (V2) network. Furthermore, as a cooperative vehicle platoon, vehicles 120A-120E can leverage their communication capabilities to function cooperatively in a manner that aims to improve traffic flow, reduce congestion, increase fuel efficiency, and enhance road safety by reducing the space between vehicles and allowing them to react simultaneously to changes in speed or direction.

In FIG. 1A, vehicle 120A, which is preceding the other platooned vehicles 120B-120E on the highway, is approaching a traffic disturbance that involves vehicle 105 abruptly braking directly in front of vehicle 120A. Consequently, with vehicle 105 being positioned in the same lane and in front of all of the vehicles 120A-120E of the cooperative vehicle platoon and suddenly braking, vehicle 105 decelerates significantly and causes the lead vehicle 120A of the platoon to also brake hard, with an even greater rate of deceleration in order to avoid colliding into the rear of vehicle 105. In some embodiments, the vehicle 120A can detect the traffic disturbance presented by vehicle 105 in real-time. Vehicle 120A can be configured to collect real-time information (e.g., vehicle speed, traffic conditions, road structures, etc.) from sensors implemented on and/or near the vehicle to detect the presence of traffic, recognize traffic patterns, detect the presence of a traffic disturbance (e.g., collision, bottleneck, braking, etc.), as well as the magnitude of the disturbance. For instance, a front camera system of vehicle 120A can observe real-time data that is indicative of the vehicle's 105 movement and created disturbance, such as the brake light application and magnitude of braking (e.g., rate of deceleration/acceleration).

Traffic disturbances that are triggered by a downstream vehicle, such as the disturbance initiated by vehicle 105, can have a direct impact on other vehicles traveling upstream in the same lane. FIG. 1B shows that in the road environment 100, the large traffic disturbance that is initially caused downstream by vehicle 105 also causes a decelerative slow-down that propagates up to the vehicles 120A-120E in the cooperative vehicle platoon. FIG. 1B illustrates that as the leading vehicle 120A has to quickly brake hard in response vehicle's 105 traffic disturbance (e.g., abrupt braking), it can further cause vehicle 120B, which is directly trailing behind vehicle 120A to also begin braking in order to decelerate and maintain a safe speed and distance back from the LV 120A. Additionally, the traffic disturbance may have a propagating effect to the remaining platooned vehicles 120B-120C. In FIG. 1C, it illustrates that vehicle 120C also has to decelerate in order to maintain its safe distance due to vehicle 120B slowing down. If the disturbance created by vehicle 105 is not mitigated, then there is a potential for its effects to continue to propagate upstream to vehicle 120D, where it would also have to decelerate in order to maintain its safe distance as the preceding vehicle 120C slows down; and so on. In other words, the leading vehicle 120A having to apply an extremely hard brake in response to the initial disturbance caused by downstream vehicle 105 (e.g., avoiding collision) creates a slow down at the very start of the platoon, which then has a likelihood to produce a ripple-effect through the FVs 102B-120E in the cooperative vehicle platoon, where the other vehicles also have to travel at a significantly reduced speed, or to become completely stopped in an extreme case. In some embodiments, vehicle 120B is configured to detect an amplification ratio of the traffic disturbance in real-time from one vehicle to the successive vehicles in the cooperative vehicle platoon. FIG. 1C illustrates that vehicle 120B can detect that the initial traffic disturbance that is triggered by vehicle 105 has an increased amplification ratio (e.g., disturbance increases) upstream. In the example, vehicle 120B can receive data that is analyzed to show with vehicle 120A having to brake in order to avoid collision with vehicle 105 that slowed down abruptly, that the disturbance is further amplified upstream as vehicle 120B itself also has to brake. Furthermore, FIG. 1C shows that the continued deceleration ripples upstream in the lane, amplifying the disturbance through the platoon, as the next vehicle 120C also has to engage braking, decreasing speed in order to maintain safe distances with the preceding vehicle 120B.

Referring back to FIG. 1A, vehicles 120A-120E of the cooperative vehicle platoon have communication capabilities (e.g., V2V connectivity) and thus the vehicles 120A-120E are shown as transmitting and/or receiving communication messages. For example, FIG. 1A illustrates that each vehicle has a V2V connection (shown as arrows) to the vehicle that is immediately following in the platoon, such as vehicle 120A as having a V2V connection established with vehicle 120B, vehicle 120B having a V2V connection established with vehicle 120C, and so on, which forms a type of vehicular network that enables communication between these platoon of vehicles. In some implementations, other wireless connections may be utilized to support communication between the platooned vehicles 120A-120E and other vehicles (e.g., not in the platoon) that are within the same vicinity (e.g., within wireless network range) on the roadway. As alluded to above, the disclosed upstream message selection techniques do not require all vehicles in an area to be communicatively connected or otherwise have wireless networking capabilities, and thus can be employed in mixed traffic environments which are more prevalent in real world applications. In the example road environment 100, vehicle 105 may be an unconnected vehicle, for instance not having wireless networking connectivity with vehicles 120A-120E in the cooperative vehicle platoon.

Vehicles 120A-120E, functioning as a cooperative vehicle platoon, have the capability to transmit and/or receive communication messages to another vehicle in the platoon via wireless connectivity (e.g., V2V) to coordinate movements, improve safety, and facilitate efficient traffic flow. Various types of communication messages can be sent between the communicatively connected vehicles 120A-120E, where the types of communication messages include Sensor Messages, Maneuver Messages (MMs), Intent Maneuver Messages (Intent MMs), Basic Safety Messages (BSMs), and the like, which are formatted in accordance with automotive technology standards and communication protocols. In particular, FIG. 1A and FIG. 1B illustrate vehicles 120A-120D in the cooperative vehicle platoon sending BSMs 121A-121D respectively upstream to the following vehicle in platoon, and at the transmission rate of 10 Hz. In the example of FIG. 1A, vehicle 120A sends the BSM 121A to the following vehicle 120B, vehicle 120B sends the BSM 121B to the following vehicle 120C, vehicle 120C sends the BSM 121C to the following vehicle 120D, and vehicle 120D sends the BSM 121D to the following vehicle 120E. Each of the BSMs 121A-121D are transmitted at the maximum frequency that vehicles are allowed to send BSMs (e.g., 10 Hz). As referred to herein, a BSM is a type of communication message that can be transmitted between communicatively connected vehicles, namely vehicles 120A-120E, that contains information and/or parameters that are related to the vehicle's movement, such as position, direction, and speed. In some embodiments, the upstream message selection systems 125A-125E are each configured to execute functions related to generating, communicating, and analyzing the aforementioned communication messages, such as BSMs 121A-121D and intent MMs, as described herein.

Accordingly, by communicating BSMs 121A-121D, a vehicle will has past status information of another vehicle in the cooperative vehicle platoon. For example, in FIG. 1C, the BSM 121A that is generated by vehicle 120A will include information such as position, direction, and speed that reflects the current status of the vehicle at the time the information is collected by vehicle 120A. However, there will some time lapse (e.g., transmission rate) that occurs by the BSM 121A is received by vehicle 120B, which causes the information to not reflect the new current real-time state of the vehicle 120A or the disturbance. Accordingly, vehicle 120C (receiving the BSM 121B in FIG. 1B) will have potentially outdated status information related to other vehicles, which may not be context-rich and predictive in the manner necessary for it to perform any action to proactively mitigate the disturbance in a manner that attenuate its effects as it propagates further upstream to the remaining vehicles in the cooperative vehicle platoon. Without the disturbance being mitigated in this way, FIG. 1C illustrates that vehicle 120B can employ its upstream message selection system 125B to detect that vehicle 120C also has to suddenly brake as a response to the traffic disturbance created downstream by vehicle 105. Thus, by sensing that the deceleration between vehicle 120A, and the FVs 102B, and 102C has not decreased, indicating that movement of cooperative vehicle platoon is not stable, vehicle 120B detects that sending BSMs 121A-121D is failing to enable the upstream vehicles in the platoon to sufficiently attenuating the disturbance initiated downstream in the lane by vehicle 105.

FIG. 1C illustrates the scenario where the upstream message selection system 125B of vehicle 120B detects that communicating BSMs 121A-121D (shown in FIG. 1A-FIG. 1B) at the highest transmission rate supported is failing to sufficiently attenuate the traffic disturbance (triggered downstream by vehicle 105) at vehicles 120A and 120B, or upstream in the platoon, namely vehicle 120C. In response to detecting that the traffic disturbance is not being sufficiently attenuated, FIG. 1C shows that vehicle 120B can transmit a request to change the type of communication message being communicated to the upstream vehicles in the platoon in an attempt to damp, or otherwise attenuate, the traffic disturbance. For example, the upstream message selection system 125B can be configured to determine that a traffic disturbance will be mitigated by dynamically changing from communicating BSMs, which indicate a vehicle's current status, to communicating intent MMs, which indicate future intended maneuvers and future trajectories of a vehicle, where the intent MMs will provide the predictive information that is useful in determining how to improve the damping properties of the platoon. As previously described, an operational goal of the cooperative vehicle platoon is to maintain a stability of speed (e.g., acceleration/deceleration) between vehicles, and thus reducing the amplification of the traffic disturbance that was caused downstream by vehicle 105 is also an aim of the cooperative vehicle platoon in the example road environment 100. Accordingly, each of the upstream message selection systems 125A-125E are distinctly configured to dynamically determine when communication messages of a certain type fail to enable the cooperative vehicle platoon to effectively attenuate a disturbance upstream, and then adaptively change in real-time a transmission rate and/or a communication message type that can enable the platoon to effectively attenuate the traffic disturbance upstream.

FIG. 1C depicts vehicle 120C of the cooperative vehicle platoon transmitting a request message 122B upstream to vehicles 120D and 120E, in response to the upstream message selection system 125C determining that changing the type of communication message would sufficiently attenuate the disturbance. The request message 122B signals to the upstream vehicles 120D and 120E that communication will be dynamically adapted from transmitting BSMs (shown in FIG. 1A and FIG. 1) to intent MMs. The request message 122B can also include additional information that is pertinent to the change in communication message type that is particularly being requested, including but not limited to: the specified frequency, intent horizon, as well as the duration of the message change. As previously described, intent MMs provide information that is predictive, such as future trajectories of other vehicles in the platoon, which can enable vehicles to analyze and determine which actions can be taken to improve the damping properties of the platoon so that the disturbance can be mitigated.

FIG. 1D illustrates a subsequent instance in the road environment 100, where the FVs in the cooperative vehicle platoon that are upstream in the lane, namely vehicles 120B-120D start broadcasting intent MMs 123B-123D, respectively. In response to the vehicles 120C-120D receiving the request message sent from vehicle 120B (shown in FIG. 1C), which is requesting the dynamic change to the type of communication messages being communicated in the platoon, each of these vehicles 120C-120D can subsequently accept the request which then initiates the transmission of intent MMs 123B-123D. As seen in FIG. 1D, vehicle 120B transmits intent MM 123B to the following vehicle 120C, vehicle 120C transmits intent MM 123C to the following vehicle 120D, and vehicle 120D transmits intent MM 123D to the following vehicle 120E. In this example, the intent MMs 123B-123D are also sent at a transmission rate of 10 Hz.

With vehicle 120C receiving the intent MM 123B, there is predictive information that is provided with respect to the intended maneuvering of vehicle 120B, for instance points where the vehicle 120B will be in the near future (e.g., next few seconds), which enables vehicle 120C to perform actions that are predicted to decay the disturbance. For instance, by having data indicating where vehicle 120B will be positioned in the next few seconds, vehicle 120C can slowly decelerate at a rate that is less abrupt than the previous vehicles 120A, 120B that is based on vehicle's 120B predicted position. In this way, upstream vehicles 120D and 120E can utilize predictive information contained in the intent MMs 123C and 123D in order to maneuver in a manner that maintains speed/distance with respect to the preceding vehicle in the platoon that is at a steadier rate (e.g., less fluctuations in peak acceleration/deceleration) and attenuates the disturbance triggered downstream by vehicle 105.

The upstream message selection systems 125A-125E can be implemented as a vehicle controller, computing hardware, software, firmware, or a combination thereof, which is programmed to select transmission rates and/or type of communication messages communicated in a plurality of connected vehicles, such as a cooperative vehicle platoon, in order to mitigate traffic disturbance in accordance with the disclosed techniques. The upstream message selection systems 125A-125E may be a standalone controller in some embodiments. Alternatively, the upstream message selection systems 125A-125E may be implemented by configuring a main vehicle onboard processor or CPU. As previously described, vehicles 120A-120E can obtain communication messages, such as BSM, intent MMs, sensor data, and other forms of data from the other communicatively connected vehicles on the road, via wireless network connectivity. This data communicated from connected vehicles can be cooperatively fused and serve as input to the upstream message selection systems 125A-125E. The upstream message selection systems 125A-125E are configured to execute various functions that support the system capabilities that are disclosed herein, including but not limited to: detecting the presence and/or attenuation of a traffic disturbance; detecting an amplification ratio of a traffic disturbance between successive vehicles in a cooperative vehicle platoon; determining an improvement/effect (e.g., increased attenuation, decay, etc.) of changing the transmission rate and/or type of communication messages on a detected traffic disturbance; changing the transmission rate and/or the type of communication message transmitted in the cooperative vehicle platoon in order to attenuate the traffic disturbance; and select a control action for a vehicle and/or cooperative control actions for multiple vehicles that is most optimal with respect to reducing the effects of the traffic disturbance for upstream vehicles in the platoon, mitigating the traffic disturbance, and further avoiding dangerous incidents (e.g., collisions, crashes, and the like).

In some embodiments, the upstream message selection systems 125A-125E are also configured to generate one or more cooperative mitigative actions that one or more vehicles in the cooperative vehicle platoon can execute in order to attenuate the downstream traffic disturbance. For example, the upstream message selection systems 125A-125E can execute processing which considers different data and factors related to the driving environment, such as the predictive information (e.g., intended maneuvers) contained in intent MMs 123B-123D, and selects cooperative mitigative actions, where cooperative mitigative actions are control actions that are taken by one or more vehicles to execute a coordinated maneuvering of these vehicles to mitigate the same traffic disturbance. In some embodiments, the upstream message selection systems 125A-125E can perform other functions related to mitigating the traffic disturbance. The upstream message selection systems 125A-125E can generate notifications, warnings, alerts, and other visual, audio, and tactile outputs that enable drivers to make safer actions in operating the vehicle, and provide additional reaction time for unexpected changes on the road. Furthermore, the upstream message selection systems 125A-125E can generate messages, notifications, warnings, alerts, for operators of other connected vehicles that may be traveling on the road within its vicinity, such as vehicles in the section of the road where vehicles 120A-120E of the cooperative vehicle platoon are currently traveling (e.g., within range of the wireless communication technology). For instance, these communication messages transmitted vehicles 120A-120E in the cooperative vehicle platoon may also be communicated to other connected vehicles and notify these respective vehicles of its selected control action (e.g., lane change, deceleration), and allow for anticipation of any cooperative maneuvers to be performed by other connected vehicles. In some implementations, the communication messages that are communicated to vehicles 120A-120E in the cooperative vehicle platoon can effectuate automated (or semi-automated) maneuvers of these vehicles. In another example, the upstream message selection systems 125A-125E may generate notifications that inform other connected vehicles about any detected traffic disturbances along the road, traffic incidents, hazards, and other changes in the traffic condition such that those drivers have additional time to revise their actions or routes accordingly.

Additionally, in response to the upstream message selection systems 125A-125E, selecting the appropriate control action(s), such as changing the type of communication message being transmitted, this data can be taken as output from the system to further notify the driver and/or effectuate automated (or semi-automated) maneuvers of the vehicles such that collisions, slowdowns, traffic congestion, and road closures are avoided. Referring back to example where the upstream message selection systems 125B selects to transmit the intent MMs 123B-123D to decay the impact of the downstream traffic disturbance, other components and/or systems of the vehicle 120C receiving the intent MM 123B may generate alerts for the driver (e.g., indicating traffic disturbance downstream), and the corresponding autonomous maneuvers (e.g., decreasing speed, changing directions, lane change, etc.) to be automatically performed in order to effectively mitigative the disturbance.

Although the example described with reference to FIG. 1A-FIG. 1D is a type of autonomous vehicle, the systems and methods described herein can be implemented in other types of vehicles including semi-autonomous vehicles, vehicles with automatic controls (e.g., dynamic cruise control), or other vehicles. Also, the vehicles 120A-120E implementing the upstream message selection systems 125A-125E described can be a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

According to an embodiment, vehicles implementing the upstream message selection systems 125A-125E (shown as vehicles 120A-120E) can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle vehicles 120A-120E along a travel route is performed by one or more computing systems, and a portion of the navigation and/or maneuvering of the vehicle vehicles 120A-120E along a travel route is performed by a human driver. One example of a semi-autonomous operational mode is when an adaptive cruise control system is activated. In such case, the speed of the vehicles 120A-120E can be automatically adjusted to maintain a safe distance from a vehicle ahead based on data received from on-board sensors, but the vehicles 120A-120E are otherwise operated manually by a human driver. Upon receiving a driver input to alter the speed of the vehicle (e.g., by depressing the brake pedal to reduce the speed of the vehicle), the speed of the vehicle is reduced. Thus, with vehicles 120A-120E operating as a semi-autonomous vehicles, a response can be partially automated. In an example, the controller communicates a newly generated (or updated) control to the vehicles 120A-120E operating as a semi-autonomous vehicles. The vehicles 120A-120E can automatically perform some of the desired adjustments (e.g., accelerating) with no human driver interaction. Alternatively, the vehicles 120A-120E may notify a driver that driver input is necessary or desired in response to a new (or updated) safety control.

Alternatively, or in addition to the above-described modes, vehicles implementing the disclosed upstream message selection systems 125A-125E (shown a vehicles 120A-120E) can have one or more autonomous operational modes. As used herein, “autonomous vehicle” means a vehicle that is configured to operate in an autonomous operational mode. “Autonomous operational mode” means that one or more computing systems of the vehicles 120A-120E are used to navigate and/or maneuver the vehicle along a travel route with a limited level of input from a human driver which varies with the operational mode. As such, vehicles 120A-120E can have a plurality of autonomous operational modes, where each mode correspondingly responds to a controller, with a varied level of automated response. In some embodiments, the vehicles 120A-120E can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle, vehicles 120A-120E responses can be highly, or fully, automated. For example, a controller can be configured to communicate controls so as to operate the vehicles 120A-120E autonomously and safely. After the controller communicates a control to the vehicles 120A-120E operating as an autonomous vehicle, the vehicles 120A-120E can automatically perform the desired adjustments (e.g., accelerating or decelerating) with no human driver interaction. Accordingly, vehicles 120A-120E can operate any of its components autonomously, such as an engine.

FIG. 1A-FIG. 1D depicts that the vehicles 120A-120D of the cooperative vehicle platoon have wireless communication capabilities. In some embodiments, vehicles 120A-120E in the cooperative vehicle platoon are also sensor-rich vehicles (SRVs) that are equipped with advanced vehicles sensors, described herein as ranging sensors (e.g., cameras, LIDAR, radar, ultrasonic sensors) and, in some cases, advanced computational resources. Particularly in the example of FIG. 1A, vehicles 120A-120E are implemented as SRVs. Accordingly, as SRVs, vehicles 120A-120E are enabled to utilize these advances sensors to sense various conditions on the roadway, and obtain data that is pertinent to traffic detection, such as, but not limited to: vehicle identifiers; the presence of other vehicles; vehicle position; vehicle speed; vehicle movement; vehicle motion direction; road data; lane data; vehicle acceleration; other static and dynamic objects; image data; planned route data; generated HD local map; processed perception data; and the like. Another subset of the plurality of vehicles in the road environment can be legacy vehicles (LVs) that have limited sensor and/or communication capabilities in comparison to the SRVs. FIG. 1A depicts an unconnected vehicle 105, which may be implemented as a LV in the mixed traffic environment 100. As described herein, LVs, such as vehicle 105, may have some sensors that are capable of sensing and limited communication of more basic types of vehicle data, such as vehicle identifiers, vehicle location, vehicle speed, vehicle acceleration, and the like. For instance, LVs can include Global Positioning System (GPS) sensors, which can provide the basic location, velocity, and acceleration of the vehicle.

Additionally, FIG. 1A-FIG. 1D illustrate wireless connections between communicatively connected vehicles 120A-120E of the cooperative vehicle platoon. Due to this wireless connectivity, data can be communicated between the connected vehicles, where the data can include information such as sensor messages, maneuver messages, basic safety messages and the like. Sensor messages can include data collected by the vehicle sensors, and other related data that may be obtained from sensors and/or devices on-board the vehicle. In some embodiments, sensor messages are implemented as a general class of wireless messages exchanged between road users and infrastructure that contains information about the objects detected in the surrounding environment. Examples of sensor messaging can include, but are not limited to Sensor Data Sharing Messages standardized by the Society of Automotive Engineers (SAE) or the Collective Perception Messages standardized by the European Telecommunications Standards Institute (ETSI).

Basic Safety Messages (BSMs) can be implemented as wireless messages transmitted between vehicles, where the transmitter sends its position, speed and other static/dynamic information. Basic safety messages are standardized by SAE. Maneuver messages (MMs) are a general class of wireless messages exchanged between road users and infrastructure that contains the future trajectory (or possible future trajectories) of the transmitting road user. Maneuver messages can be a communication or instruction related to a specific driving maneuver or action, such as turning, changing lanes, merging, or stopping. For example, maneuver messages can contain information related to a vehicle's intended maneuver, such as its direction, speed, and position, to enable other vehicles or systems to respond accordingly. Examples of maneuver messages include, but are not limited to: Intent Maneuver Messages (Intent MMs); Negotiation Maneuver Messages (Negotiation MMs); Maneuver Coordination Message (MCM) as standardized by ETSI; and Maneuver Sharing Coordination Message (MSCM) as standardized by SAE.

As previously described, connected vehicles are configured to utilize types of wireless networking technology that are suitable for vehicles, which enables a vehicle to wirelessly communicate with other vehicles, infrastructure, and communication points. In the example of FIG. 1A-FIG. 1E, vehicles 120A-120E in the cooperative vehicle platoon are equipped with vehicle-to-vehicle (V2V) communication capabilities. Thus, vehicles 120A-120E utilize V2V communication ability to form a communication network (as the vehicles are within range for V2V-based wireless communication), and wirelessly exchange information, such as maneuver messages, sensor data (e.g., speed and position of surrounding vehicles), and the like. That is, in the road environment 100 of FIG. 1A-FIG. 1D, V2V enables at least vehicles 120A-120E in the platoon to be able to communicate with each other. Vehicles 120A-120E can receive and analyze data that is communicated over the formed wireless communication network, and employ other vehicle components and/or systems, such as the upstream message selection systems 125A-125E, to help perform automated actions that avoid crashes, eases traffic congestion, and overall improves the road environment 100.

In some embodiments, the connected vehicles, namely vehicles 120A-120E, are configured to utilize other forms of wireless networking technology, such as vehicle-to-infrastructure (V2I) and/or vehicle-to-everything (V2X) capabilities. Accordingly, vehicles 120A-120E can employ V2I and/or V2X communication to wireless exchange additional data between the vehicles and road infrastructure. Thus, in some cases, road environment 100 may include infrastructure components such as lane markings, road signs, and traffic lights which can wirelessly provide information to the vehicle, and vice versa. Consequently, the data communicated to/from connected vehicles can include additional data obtain from these infrastructure components in V2I and/or V2X communication, allowing the upstream message selection systems 125A-125E to have a vast amounts real-time, information rich, data that is related to road safety, energy savings, and traffic efficiency on the roads in order to further enhance the accuracy and the overall performance of its traffic congestion mitigation functions. In some embodiments, the vehicles 120A-120E are further configured to employ the bidirectional communication of V2I and/or V2X to also provide the roadside units, cloud/edge servers, and traffic monitoring centers, with notifications of traffic congestion that it has detected and mitigative maneuvers (e.g., control actions) to be performed, when required and/or requested from the infrastructure.

FIG. 1A-FIG. 1D illustrate an example system for implementing the disclosed upstream message selection techniques, which leverages cooperative capabilities between communicatively connected vehicles, traveling as a cooperative vehicle platoon, in order determine a transmission rate and/or type of communication message that may be communicated to upstream vehicles in a manner that efficiently reduces the impact of a traffic disturbance, including traffic congestion. By dynamically changing the type of communication messages that are transmitted, in response to a detected downstream traffic disturbance, the disclosed upstream message selection system and techniques can improve the damping properties of the platoon vehicles in a manner that increases vehicle safety, reduces traffic jams, improves energy efficiency, and improves operator comfort, in addition to reducing channel load (e.g., unnecessarily increasing the frequency of messages that will not mitigate the disturbance).

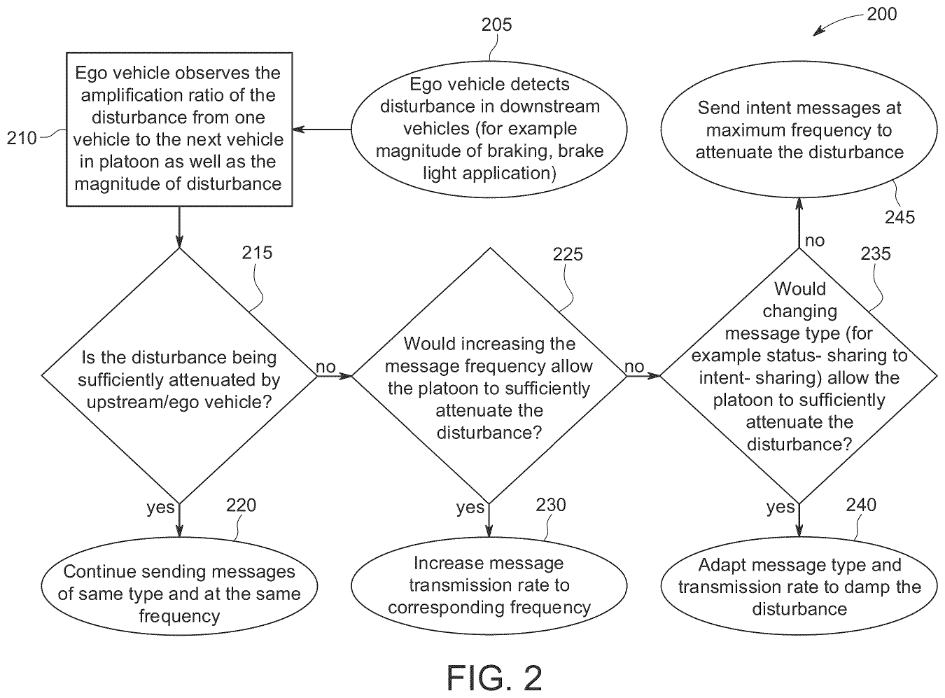

FIG. 2 is a flow diagram of an example method, depicted as process 200, that is performed according to one embodiment of the systems and methods described herein. The process 200 can be a series of executable operations in a machine-readable storage media performed by a hardware processor. A computing component can be a computer device used for implementing the disclosed upstream message selection functions described herein. For example, the computing component may be the controller of a vehicle implementing the upstream message selection system described above in reference to FIG. 1A-FIG. 1D. As a general description, process 200 depicts a method for implementing a technique which a communication message type in a cooperative vehicle platoon can be dynamically changed when it is determined that increasing a frequency (e.g., transmission rate) of an initial type of communication message, such as communication messages transmitted as BSMs, fails to sufficiently mitigate a traffic disturbance. In some cases, the method 200 generally operates to change the communication message type from BSMs to intent MMs for the upstream vehicles in the cooperative vehicle platoon based on the response to a downstream traffic disturbance in a manner that improves the damping properties of the platoon tail and ultimately mitigates the traffic disturbance.

The process 200 can begin at operation 205, where an ego vehicle detects a traffic disturbance that may be occurring downstream in the in the vehicle traffic, for instance on a road or highway. For example, the ego vehicle may detect that a vehicle traveling ahead in the lane is abruptly braking, which may impeded the progress of other vehicles traveling behind in the same lane that are moving at a greater speed. The ego vehicle may be operating as part of a cooperative vehicle platoon, for instance being positioned as the lead vehicle (LV) of the platoon. In some embodiments, the ego vehicle may detect the traffic disturbance that triggered by a downstream vehicle by employing its various sensor devices and capabilities, such as a font camera system sensing the magnitude of the disturbance vehicle's braking or a degree of illuminance of the disturbance vehicle's rear brake light application.

Thereafter, the process 200 can continue to operation 210 where the ego vehicle observes an amplification ratio of the traffic disturbance between successive vehicles in the cooperative vehicle platoon. Operation 210 also involves the ego vehicle observing the magnitude of the traffic disturbance. According to the embodiments, the vehicles in the cooperative vehicle platoon are communicatively connected in a manner that allows vehicles to transmit and/or receive communication messages, such as BSMs, to the vehicle that is immediately trailing in the platoon. Thus, a vehicle is receiving status information about another vehicle in the platoon, which can then be analyzed to determine whether upstream vehicles in the platoon are also experiencing an impact (e.g., severe braking, fluctuations in acceleration/deceleration) from the traffic disturbance that was initially triggered downstream. That is, operation 210 can involve determining whether the traffic disturbance, which was initiated by a vehicle downstream, may cause the LV to respond in a manner (e.g., hard braking) that has an impact which increasingly propagates (e.g., increasing amplification ratio) to each successively upstream vehicle in the platoon.

Next, at operation 215, a conditional check 215 is performed in order to determine whether the traffic disturbance is being sufficiently attenuated for the upstream vehicles in the cooperative vehicle platoon. For example, by observing the amplification ratio between successive vehicles in the platoon in previous operation 210, it can be determined whether the traffic disturbance is being amplified, having an adverse impact on upstream vehicles in the platoon, or whether the traffic disturbance is being amplified, where the effects of the traffic disturbance being to progressively decay for vehicles upstream in the platoon. According to the embodiments, determining whether a traffic disturbance is being sufficiently attenuated can include observing one or more operational factors in the cooperative vehicle platoon that indicate that the effects of the disturbance are tapering off in platoon, where the factors include but are not limited to: keeping the platoon string stable from each preceding vehicle to a FV (e.g., the peak acceleration/deceleration from each preceding vehicle to a FV should decrease); and ensuring that the velocity/acceleration fluctuations at the platoon tail are bounded (e.g., the acceleration magnitude of the tail vehicle should not exceed 2 m/s²).

In the case where it is detected in operation 215 that the traffic disturbance is being sufficiently attenuated by the upstream vehicles in the cooperative vehicle platoon (shown as “Yes” in FIG. 2), then the process 200 continues to operation 220. At operation 220, it can be determined that continuing to send communication messages of the current communication type and/or at the current frequency is sufficiently attenuating the disturbance for the upstream vehicles in the platoon. Thus, no change is needed in order to mitigate the traffic disturbance. For instance, if the traffic disturbance is currently being attenuated for the upstream vehicles in the cooperative vehicle platoon by sending communication messages at an initial type of BSMs at the initial transmission rate of 5 Hz, then operation 220 continues to send at BSMs at the 5 Hz frequency, as this current approach will be effective to mitigate the traffic disturbance.

Conversely, in the case where it is detected in operation 215 that the traffic disturbance is not being sufficiently attenuated by the upstream vehicles in the cooperative vehicle platoon (shown as “No” in FIG. 2), then the process 200 continues to operation 225. At operation 225, another conditional check is performed to determine whether a change in the frequency of transmitting the communication messages will better attenuate the traffic disturbance for the upstream vehicles in the platoon. In the case when it is determined in operation 225 that changing the frequency will be effective to attenuate the traffic disturbance (shown as “Yes” in FIG. 2), then the process 200 moves to operation 230 where an updated transmission rate is selection. For example, operation 230 can involve determining that utilizing an updated transmission rate that is increased from the initial transmission rate (e.g., frequency at which communication messages are currently being communicated at in the cooperative vehicle platoon) will allow the upstream vehicles to have more recent status information for the preceding vehicles in a manner that enables the trailing vehicles in platoon to maneuver to reduce the disturbance. For instance, if it is determined that increasing the frequency of the communication messages will effectively attenuate the traffic disturbance for the upstream vehicles in the cooperative vehicle platoon, then operation 230 can continue to send communication messages at the initial type of BSMs in the platoon, but increases the previously used initial transmission rate of 5 Hz to the higher updated transmission rate of 10 Hz in real-time for sending subsequent BSMs in the platoon.

Returning back to operation 225, if it is determined that a change in the frequency of transmitting the communication messages will still fail to sufficiently attenuate the traffic disturbance for the upstream vehicles in the platoon another (shown as “No” in FIG. 2), then the process 200 goes to operation 235. In other words, operation 225 determines whether using an increased updated transmission rate will be effective for attenuating the traffic disturbance for vehicles in the platoon before an unnecessary additional load is placed on the communication channel by increasing the frequency of communication messages. At operation 235 another conditional check is performed to determine whether a change in the type of the communication messages will sufficiently attenuate the traffic disturbance for the upstream vehicles in the platoon. In the case when it is determined that a change in the type of the communication messages transmitted in the cooperative vehicle platoon will not sufficiently attenuate the traffic disturbance for upstream vehicles in the platoon (shown as “No” in FIG. 2), then the process 200 goes to operation 245. At operation 245, the type of communication messages is maintained, however the maximum frequency is utilized, so that communication messages are transmitted at the maximum transmission rate that is supported by the platoon in an attempt to mitigate the disturbance.

In the case when it is determined in operation 235 that changing the type will sufficiently attenuate the traffic disturbance (shown as “Yes” in FIG. 2), then the process 200 proceeds to operation 240 where the type of the communication messages that is currently being communicated in the cooperative vehicle platoon is dynamically changed. For instance, if it is determined that changing to an updated type of communication messages will effectively attenuate the traffic disturbance for the upstream vehicles in the cooperative vehicle platoon, then operation 240 can dynamically change from sending communication of the initial type of BSMs in the platoon to sending communicating communication messages of the updated type, namely intent MMs, in the platoon in order to decay the disturbance upstream through the platoon. Thus, method 200 can dynamically change the type of communication messages that are transmitted upstream in the cooperative vehicle platoon, in response to the downstream traffic disturbance. As previously described, communicating messages that have more predictive information regarding the intended positions and/or maneuvers of preceding vehicles in the platoon in response to the traffic disturbance (e.g., intent MMs) can improve the damping properties of the trailing vehicles of the platoon in a manner that ultimately mitigates the traffic disturbance, increases vehicle safety, reduces traffic jams, improves energy efficiency, and improves operator comfort, in addition to reducing channel load (e.g., unnecessarily increasing the frequency of messages that will not mitigate the disturbance).

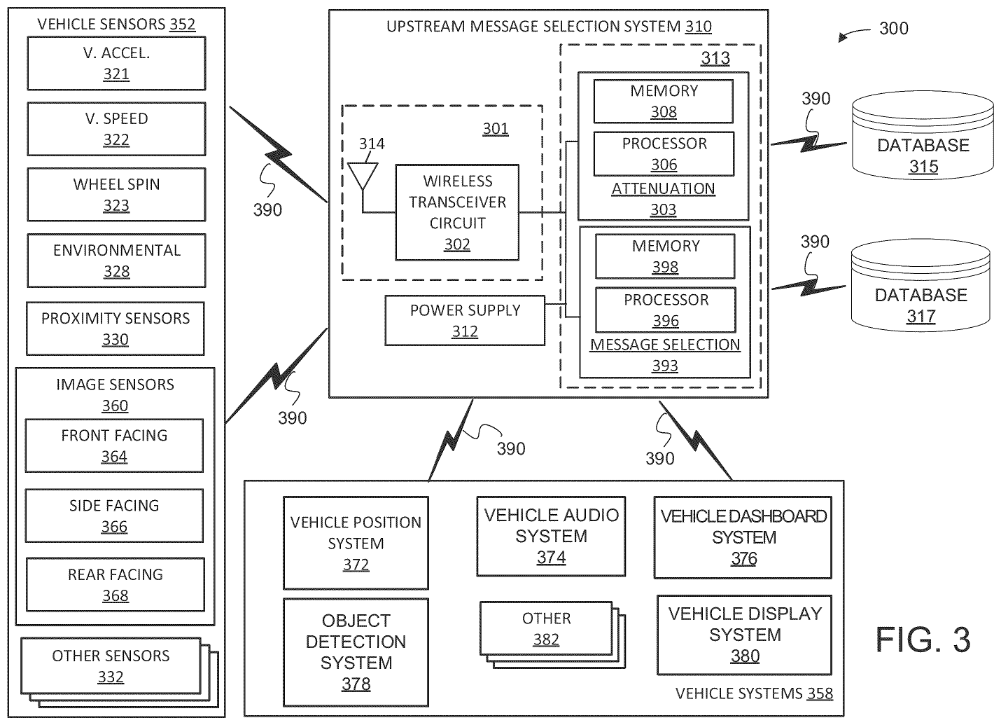

FIG. 3 depicts an example network architecture of in-vehicle upstream message selection system in accordance with one embodiment of the systems and methods described herein. The vehicle 300 implementing an upstream message selection system includes a upstream message selection system circuit 310 communicatively connected to a plurality of sensors 352, a plurality of vehicle systems 358, a database 315 comprising roadway data, and a database 317. Sensors 352 and vehicle systems 358 wirelessly communicate with the upstream message selection system circuit 310. Although in this example sensors 352 and vehicle systems 358 are depicted as communicating with upstream message selection system circuit 310, they can also communicate with each other as well as with other vehicle systems. The upstream message selection system circuit 310 can be implemented as an ECU or as part of an ECU. In other embodiments, the upstream message selection system circuit 310 can be implemented independently of the ECU.

The upstream message selection system circuit 310 in this example includes a communication circuit 301, a controller/CPU 313 comprising an attenuation engine 303, and a message selection engine 393, and a power supply 312. Each engine includes a respective processor 306, 396 and respective memory 308, 396. For example, the attenuation engine 303 includes a processor 306, and a memory 308 configured for performing the functions associated with detecting the presence and attenuation of a traffic disturbance in relation to the cooperative vehicle platoon described herein, and the message selection engine 393 includes a processor 396 and a memory 398 configured for performing functions associated with determining a communication message type and/or transmission rate necessary for decaying the traffic disturbance in relation to the cooperative vehicle platoon, as described herein.

Processor 306 can include one or more GPUs, CPUs, microprocessors, or any other suitable processing system. Processor 306 may include a single core or multicore processors. The memory 308 may include one or more various forms of memory or data storage (e.g., flash, RAM, etc.) that may be used to store instructions and variables for processor 306 as well as any other suitable information, such as, one or more of the following elements: rules data; resource data; GPS data; and base data, as described below. Memory 308 can be made up of one or more modules of one or more different types of memory, and may be configured to store data and other information as well as operational instructions that may be used by the processors 306 and 396.

Although the example of FIG. 3 is illustrated using processor and memory circuitry, as described below with reference to circuits disclosed herein, controller/CPU 313 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the mitigative action selection circuit 310. Communication circuit 301 includes either or both a wireless transceiver circuit 302 with an associated antenna 314 and a wired I/O interface with an associated hardwired data port (not illustrated). Communication circuit 301 can provide for V2X communications capabilities, allowing the mitigative action selection circuit 310 to communicate with edge devices, such as roadside equipment (RSE), network cloud servers and cloud-based databases, and/or other vehicles.

As this example illustrates, communications with the mitigative action selection circuit 310 can include either or both wired and wireless communications circuits 301. Wireless transceiver circuit 302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by the mitigative action selection circuit 310 to/from other entities such as sensors 352 and vehicle systems 358.

Power supply 312 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

In the illustrated example, sensors 352 include vehicle acceleration sensors 321, vehicle speed sensors 322, wheelspin sensors 323 (e.g., one for each wheel), environmental sensors 328 (e.g., to detect salinity or other environmental conditions), proximity sensor 330 (e.g., sonar, radar, lidar or other vehicle proximity sensors), and image sensors 360. Additional sensors (i.e., other sensors 332) can be included as may be appropriate for a given implementation of the upstream message selection system for the vehicle 300.

The sensors 352 include front facing image sensors 364, side facing image sensors 366, and/or rear facing image sensors 368. Image sensors may capture information which may be used in detecting not only vehicle conditions but also detecting conditions external to the ego vehicle 120A (shown in FIG. 1A) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 360 can be used to, for example, to detect objects in an environment surrounding ego vehicle 120A, for example, traffic signs indicating a current speed limit, road curvature, obstacles, surrounding vehicles, and so on. For example, one or more image sensors 360 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 360 may include cameras that may be used with and/or integrated with other proximity sensors 330 such as LIDAR sensors or any other sensors capable of capturing a distance. As used herein, a sensor set of a vehicle may refer to sensors 352 and image sensors 360 as a set.

Vehicle systems 358 include any of a number of different vehicle components or subsystems used to control or monitor various aspects of the vehicle and its performance. In this example, the vehicle systems 358 includes a vehicle positioning system 372; vehicle audio system 374 comprising one or more speakers configured to deliver audio throughout the vehicle; object detection system 378 to perform image processing such as object recognition and detection on images from image sensors 360, proximity estimation, for example, from image sensors 360 and/or proximity sensors, etc. for use in other vehicle systems; suspension system 380 such as, for example, an adjustable-height air suspension system, or an adjustable-damping suspension system; and other vehicle systems 382 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 372 includes a global positioning system (GPS). Ego vehicle 120A and the one or more connected vehicles 120B-120E (shown in FIG. 1A-FIG. 1D) may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 390 may be a conventional type of network, wired or wireless, and may have numerous different configurations including a star configuration, token ring configuration, or other configurations. Furthermore, the network 390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 390 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 1390 may include one or more IEEE 802.11 wireless networks.

In one embodiment, data comprising the location of vehicle is captured by the vehicle position system 358. The vehicle position system 358 can include one or more sensors 352 configured to capture vehicle position data. The vehicle positioning system 372 communicates with the mitigative action selection circuit 310 to communicate and utilize mitigative actions at the ego vehicle 120A for various driving and/or maneuvering functions, including autonomous or semi-autonomous vehicle/driver safety features.

In an embodiment, the upstream message selection system circuit 310 produces notifications for the driver of the ego vehicle 120A using one or more notification methods. For example, the driver may receive a visual and/or audible notification that the vehicle may need to perform a maneuver to avoid an approaching traffic incident and/or traffic congestion, based on data that the upstream message selection system circuit 310 has analyzed accordance with the upstream message selection capabilities, as disclosed herein. In one embodiment, the notification methods include the vehicle systems 358 comprising the vehicle audio system 372 and the vehicle dashboard system 376. The notification methods includes visual and/or audible methods of informing the driver of safety related issues. In one embodiment, the notification methods include notifying the driver of the ego vehicle 120A via one or more vehicle systems 358. For example, in one embodiment, the driver is notified of a selected message type via the vehicle audio system 374 (e.g., instructions played/broadcasted over one or more vehicle speakers), the vehicle display system 380 and/or the vehicle dashboard system 376. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the upstream message selection system circuit 310 to the driver).

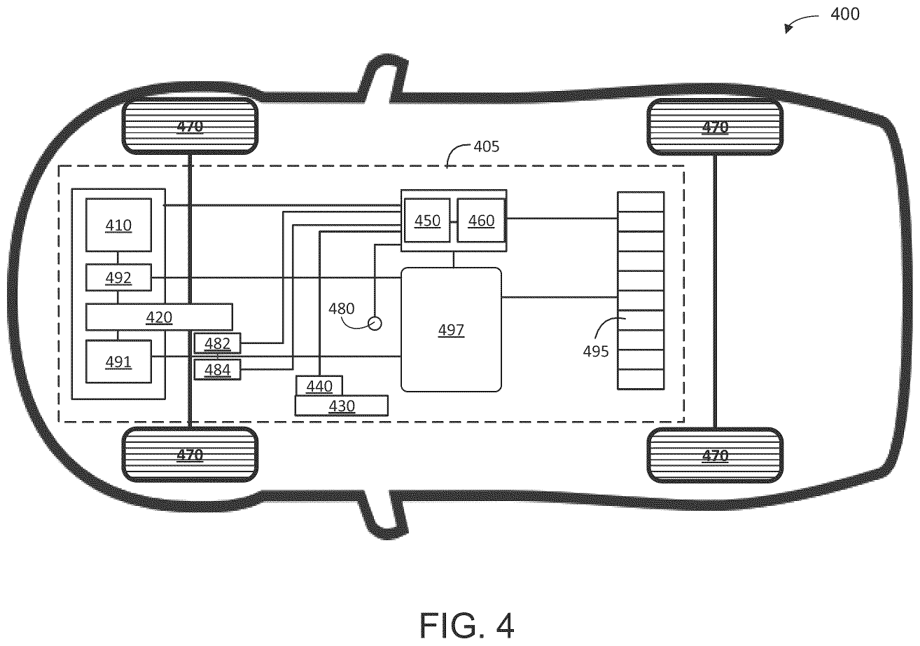

FIG. 4 illustrates an example hybrid electric vehicle (HEV) 400 in which various embodiments for the upstream message selection system are implemented. For example, in one embodiment, the ego vehicle 120A (shown in FIG. 1A) is a HEV 400. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 400 includes drive force unit 405 and wheels 470. Drive force unit 405 includes an engine 410, motor generators (MGs) 491 and 492, a battery 495, an inverter 497, a brake pedal 430, a brake pedal sensor 440, a transmission 420, a memory 460, an electronic control unit (ECU) 450, a shifter 480, a speed sensor 482, and an accelerometer 484.

Engine 410 primarily drives the wheels 470. Engine 410 can be an ICE that combusts fuel, such as gasoline, ethanol, diesel, biofuel, or other types of fuels which are suitable for combustion. The torque output by engine 410 is received by the transmission 420. MGs 491 and 492 can also output torque to the transmission 420. Engine 410 and MGs 491 and 492 may be coupled through a planetary gear (not shown in FIG. 4). The transmission 420 delivers an applied torque to the wheels 470. The torque output by engine 410 does not directly translate into the applied torque to the wheels 470.

MGs 491 and 492 can serve as motors which output torque in a drive mode, and can serve as generators to recharge the battery 495 in a regeneration mode. The electric power delivered from or to MGs 491 and 492 passes through inverter 497 to battery 495. Brake pedal sensor 440 can detect pressure applied to brake pedal 430, which may further affect the applied torque to wheels 470. Speed sensor 482 is connected to an output shaft of transmission 420 to detect a speed input which is converted into a vehicle speed by ECU 450. Accelerometer 484 is connected to the body of HEV 400 to detect the actual deceleration of HEV 400, which corresponds to a deceleration torque.

Transmission 420 is a transmission suitable for an HEV. For example, transmission 420 can be an electronically controlled continuously variable transmission (ECVT), which is coupled to engine 410 as well as to MGs 491 and 492. Transmission 420 can deliver torque output from a combination of engine 410 and MGs 491 and 492. The ECU 450 controls the transmission 420, utilizing data stored in memory 460 to determine the applied torque delivered to the wheels 470. For example, ECU 450 may determine that at a certain vehicle speed, engine 410 should provide a fraction of the applied torque to the wheels while MG 491 provides most of the applied torque. ECU 450 and transmission 440 can control an engine speed (NE) of engine 440 independently of the vehicle speed (V).

ECU 440 may include circuitry to control the above aspects of vehicle operation. ECU 440 may include, for example, a microcomputer that includes a one or more processing units (e.g., microprocessors), memory storage (e.g., RAM, ROM, etc.), and I/O devices. ECU 440 may execute instructions stored in memory to control one or more electrical systems or subsystems in the vehicle. ECU 440 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 441 and 442 each may be a permanent magnet type synchronous motor including for example, a rotor with a permanent magnet embedded therein. MGs 441 and 442 may each be driven by an inverter controlled by a control signal from ECU 440 so as to convert direct current (DC) power from battery 445 to alternating current (AC) power, and supply the AC power to MGs 441, 442. MG 442 may be driven by electric power generated by motor generator MG 441. It should be understood that in embodiments where MG 441 and MG 442 are DC motors, no inverter is required. The inverter, in conjunction with a converter assembly may also accept power from one or more of MGs 441, 442 (e.g., during engine charging), convert this power from AC back to DC, and use this power to charge battery 495 (hence the name, motor generator). ECU 450 may control the inverter, adjust driving current supplied to MG 492, and adjust the current received from MG 491 during regenerative coasting and braking.

Battery 495 may be implemented as one or more batteries or other power storage devices including, for example, lead-acid batteries, lithium ion, and nickel batteries, capacitive storage devices, and so on. Battery 495 may also be charged by one or more of MGs 491, 492, such as, for example, by regenerative braking or by coasting during which one or more of MGs 491, 492 operates as generator. Alternatively (or additionally, battery 495 can be charged by MG 491, for example, when HEV 400 is in idle (not moving/not in drive). Further still, battery 495 may be charged by a battery charger (not shown) that receives energy from engine 410. The battery charger may be switched or otherwise controlled to engage/disengage it with battery 495. For example, an alternator or generator may be coupled directly or indirectly to a drive shaft of engine 410 to generate an electrical current as a result of the operation of engine 410. Still other embodiments contemplate the use of one or more additional motor generators to power the rear wheels of a vehicle (e.g., in vehicles equipped with 4-Wheel Drive), or using two rear motor generators, each powering a rear wheel.

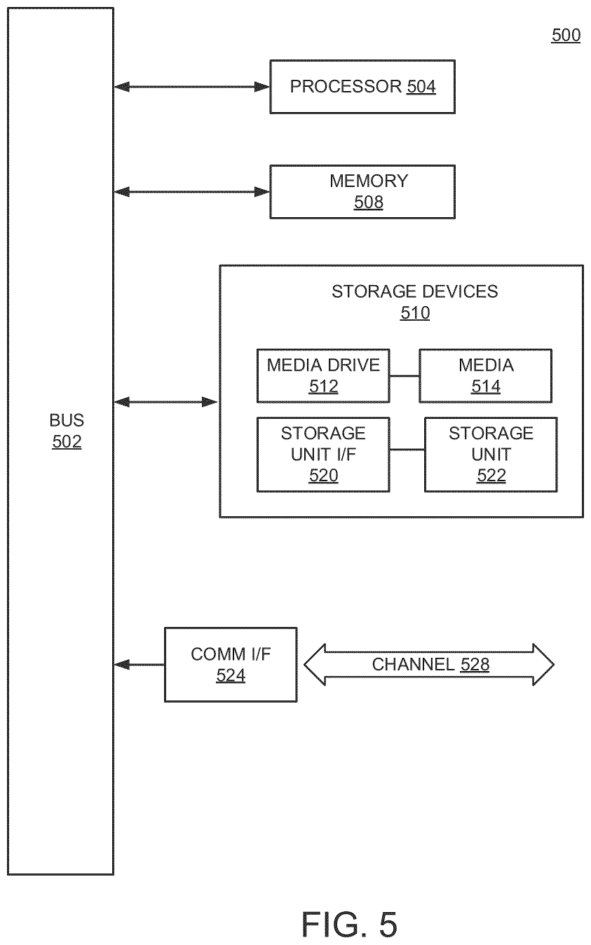

Battery 495 may also be used to power other electrical or electronic systems in the vehicle. Battery 495 can include, for example, one or more batteries, capacitive storage units, or other storage reservoirs suitable for storing electrical energy that can be used to power MG 1491 and/or MG 492. When battery 495 is implemented using one or more batteries, the batteries can include, for example, nickel metal hydride batteries, lithium ion batteries, lead acid batteries, nickel cadmium batteries, lithium ion polymer batteries, and other types of batteries.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor 504. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 1522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a processor device analyzing data associated with a driving environment of a vehicle and selecting an updated transmission rate or an updated type of communication messages for the vehicle to transmit in response to a traffic disturbance detected in the driving environment, wherein the data comprises communication messages of an initial type transmitted at an initial transmission rate by a plurality of communicatively connected vehicles in the driving environment; and
a controller device executing autonomous actions to maneuver the vehicle based on the updated type of communication messages for the vehicle.

2. The system of claim 1, wherein the plurality of communicatively connected vehicles in the driving environment comprise a cooperative vehicle platoon.

3. The system of claim 2, wherein the vehicle comprises a leading vehicle in the cooperative vehicle platoon and the traffic disturbance is detected in the driving environment downstream from the vehicles in the cooperative vehicle platoon.

4. The system of claim 3, wherein the processor device detects whether the communication messages transmitted by the vehicles attenuate the traffic disturbance for vehicles in the cooperative vehicle platoon.

5. The system of claim 4, wherein the processor device determines to dynamically change from transmitting the communication messages at the initial transmission rate to transmitting the communication messages at the updated transmission rate in the cooperative vehicle platoon.

6. The system of claim 5, wherein the processor device dynamically changing to the updated transmission rate is in response to detecting that transmitting the communication messages by the vehicles at the initial transmission rate fails to attenuate the traffic disturbance for the vehicles in the cooperative vehicle platoon.

7. The system of claim 6, wherein the processor device determines to dynamically change from transmitting communication messages of the initial type to transmitting communications messages of the updated type in the cooperative vehicle platoon.

8. The system of claim 7, wherein the processor device dynamically changing to the updated message type is in response to detecting that transmitting the communication messages of the initial type by the vehicles at the updated transmission rate fails to attenuate the traffic disturbance for the vehicles in the cooperative vehicle platoon.

9. The system of claim 8, wherein the initial type of communication messages comprises basic safety messages.

10. The system of claim 8, wherein the updated type of communication messages comprises intent maneuver messages.

11. The system of claim 1, wherein the controller device executes autonomous actions to maneuver the vehicle such that acceleration fluctuations at the tail of the cooperative vehicle platoon are bounded.

12. The system of claim 1, wherein the controller device executes autonomous actions to maneuver the vehicle such that a peak deceleration decreases between each of the successive vehicles in the cooperative vehicle platoon.

13. A non-transitory computer readable medium comprising instructions, that when read by a processor, cause the processor to perform:
analyzing data associated with a driving environment of a vehicle and selecting an updated transmission rate or an updated type of communication messages for the vehicle to transmit in response to a traffic disturbance detected in the driving environment, wherein the data comprises communication messages of an initial type transmitted at an initial transmission rate by a plurality of communicatively connected vehicles in the driving environment; and
executing autonomous actions to maneuver the vehicle based on the updated type of communication messages for the vehicle.

14. The non-transitory computer readable medium of claim 13, wherein the plurality of communicatively connected vehicles in the driving environment comprise a cooperative vehicle platoon.

15. The non-transitory computer readable medium of claim 14, comprising instructions that cause the processor to further perform:
detecting whether the communication messages transmitted by the vehicles attenuate the traffic disturbance for vehicles in the cooperative vehicle platoon.

16. The non-transitory computer readable medium of claim 15, comprising instructions that cause the processor to further perform:
determining to dynamically change from transmitting the communication messages at the initial transmission rate to transmitting the communication messages at the updated transmission rate in the cooperative vehicle platoon.

17. The non-transitory computer readable medium of claim 16, comprising instructions that cause the processor to further perform:
dynamically changing to the updated transmission rate is in response to detecting that transmitting the communication messages by the vehicles at the initial transmission rate fails to attenuate the traffic disturbance for the vehicles in the cooperative vehicle platoon.

18. The non-transitory computer readable medium of claim 17, comprising instructions that cause the processor to further perform:
determining to dynamically change from transmitting communication messages of the initial type to transmitting communications messages of the updated type in the cooperative vehicle platoon.

19. The non-transitory computer readable medium of claim 18, comprising instructions that cause the processor to further perform:
dynamically changing to the updated message type is in response to detecting that transmitting the communication messages of the initial type by the vehicles at the updated transmission rate fails to attenuate the traffic disturbance for the vehicles in the cooperative vehicle platoon.

20. The non-transitory computer readable medium of claim 19, wherein the initial type of communication messages comprises basic safety messages and the updated type of communication messages comprises intent maneuver messages.
